(19) United States
(12) Patent Application Publication
(10) Pub. No.: US 2026/0024300 A1
(43) Pub. Date: Jan. 22, 2026

(54) METHOD FOR PROCESSING AT LEAST ONE IMAGE

(71) Applicant: 36ZERO VISION GMBH, Munich (DE)

(72) Inventor: Muhammad Zeeshan KARAMAT, Munich (DE)

(21) Appl. No.: 19/119,943

(22) PCT Filed: Oct. 8, 2023
(86) PCT No.: PCT/EP2023/077812

§ 371 Date: Apr. 10, 2025

(30) Foreign Application Priority Data
Oct. 11, 2022 (LU) LU502889

(51) Int. Cl. G06V 10/26; G06V 10/25; G06V 10/774; G06V 10/82

(52) U.S. Cl. CPC G06V 10/273; G06V 10/25; G06V 10/774; G06V 10/82; G06V 2201/07

(57) ABSTRACT

The invention relates to a method for processing at least one image (1), wherein the method comprises the following steps: receiving of image data. inputting the unmasked image data to an artificial neural network for detecting one or more pretrained target areas (3). detecting one or more region of interests (2) in the image (1) and creating an image mask that is dependent on the one or more region of interests (2) and applying the created image mask on the image data for removing an image region (4) that does not comprise the one or more region of interests (2).

The invention relates to a method for processing at least one image. Additionally, the invention relates to a data processing device and an image acquisition device comprising such a data processing device.

In addition, the invention relates to a computer program product, a computer readable medium and a data carrying signal.

Image processing by means of using an artificial neural network is known from the prior art. Neural networks can be used to detect pretrained target areas in an image. Thereto, a mask is applied on the image to remove the image part that is not of interest for the application. Afterwards, the masked image data is inputted to the neural network. However, neural networks provide accurate results when the input data is normally distributed. For example, the neural network works well if color values are normally distributed. Applying a mask to remove one or more image parts that are not of interest results in that the color values are not normally distributed in the remaining image data that is inputted to the neural network. This results in that the pretrained target areas are not accurately recognized by the neural network. The same problem applies in the training process when training images are applied to the neural network. This results in that the neural network cannot be trained such to provide accurate results.

The object of the invention is to provide a method by means of which the pretrained target areas can be recognized more accurate.

The object is solved by a method for processing at least one image, wherein the method comprises the following steps:
receiving of image data,
inputting the unmasked image data to an artificial neural network for detecting one or more pretrained target areas,
detecting one or more region of interests in the image and creating an image mask that is dependent on the one or more region of interests and
applying the created image mask on the image data for removing an image region that does not comprise the one or more region of interests.

According to the invention unmasked image data is inputted to the neural network. This ensures that the inputted data, in particular color value, in the normal operation or in the training process is normally distributed. Thus, the neural network provides accurate results. In particular, the neural network detects the one or more pretrained target areas in an accurate manner. It was recognized that the detection of the target area and the detection of the region of interest shall be executed separately from each other. In particular, the same image data is used for the detection of the target area and the region of interest. This results in better results than masking the received image data before it is inputted to the neural network.

As is described later more in detail by removing the image region that does not comprise the one or more region of interest it is possible to identify the target areas that are of interest for the user and/or application in an easy manner. This has the advantage that the training is simplified as the training can be focused to identify the region of interests and target areas. That means, all other non-interesting objects do not have to be trained and the training is independent from those non-interesting region of interests, in particular non-interesting objects. The training can be performed separately for the target area and for the region of interest which also simplifies the training. Another advantage of the invention is that the separate detection of the one or more target areas and the one or more region of interests improves the hardware performance in the training and operation phase. A further advantage of the invention is that the separate detection of several region of interests that can overlap or not enables to apply parallelly and combine different detections of one or more target area for each region of interest.

With “pretrained” it is meant that the neural network is trained in a training process on the basis of training images to detect the target area.

The pretrained target area can be flexibly selected. It can be one or more parts of one or more objects. Alternatively, the pretrained target area can be an object or several objects. The pretrained target area can depend on the application in which the method is used. If the method is used for quality inspection, the pretrained target area can be one or more defects, for example a scratch. In the inventive method the one or more defect is of interest that is arranged in the region of interest, in particular an object. Alternatively, the pretrained target area can be a color of an object or object part so that it can be checked whether the object or the object part has the predetermined color. A further example is that the pretrained target area can be several parts of an object so that the method checks whether the image data comprises said several object parts. If this is not the case, then a mistake in the object manufacturing might have occurred.

The expression “detection one or more pretrained target areas” means that the neural network determines all pretrained target areas in the inputted image. Thus, the output of the neural network is whether one or more pretrained target areas is or are present in the image, in particular in the image data. This also includes the case that the image does not comprise a target area. In said case the neural network's output is that the image does not comprise a target area.

The expression “detection one or more region of interests” means that all region of interests are determined in the inputted image. This also includes the case that it is determined that the inputted image does not comprise a region of interest. In said case the image mask will remove the total image as the total image is considered as non-interesting. The region of interest can be part of the image or can cover the complete image.

With “unmasked image data” it is meant that the image data correspond to the original image data that is acquired by the image acquisition device. By applying the image mask on the received image data, said data are changed, i.e. masked, so that they do not correspond to the original image data. If the region of interest covers the complete image, no image part is removed by means of applying the image mask.

If more than one image is obtained, each image is processed in the aforementioned manner. That means, for each of the images the one or more pretrained target areas are detected and the one or more region of interest is detected. Additionally, for each of the images an image mask is created and the respective image mask is applied to the respective image. It is clear that the image data that is received in the inventive method corresponds to the image, in particular to the obtained image.

The method can be executed in a data processing device. The data processing device can comprise one or more processors or can be a processor. Alternatively, the data processing device can be a computer. The image data obtained by the image acquisition device is sent to the data processing device. Thus, the data processing device receives said image data from the image acquisition device and processes said image data.

According to an embodiment the data processing device can process said image data so that one or more pretrained target areas arranged in at least one, in particular pretrained, region of interest are detected. Thereto, the position of the pretrained target areas and the position of the, in particular pretrained, region of interest can be determined. Thus, it is possible to determine whether the detected pretrained target areas are arranged in the, in particular pretrained, region of interest. The one or more pretrained target areas that are arranged in at least one, in particular pretrained, region of interest can be outputted by the neural network. This is only possible if the image data comprises one or more pretrained target areas. The one or more pretrained target areas that are arranged in at least one, in particular pretrained, region of interest are the target areas that are of relevance for the user. As the pretrained target areas can be accurately detected because they are separately detected from the, in particular pretrained, region of interest, it is possible to consider all pretrained target areas of interest. As is discussed later below, the other pretrained target areas that are not arranged in the region of interest can be ignored for further processing of the image data or of the pretrained target areas.

The one or more pretrained region of interests can be detected before the image mask is applied on the obtained image. As it is explained below, the one or more pretrained region of interest can be detected independent on the detection of the pretrained target areas or vice versa. That means, the one or more pretrained region of interest can be detected before the detection of the pretrained target areas or parallel to the detection of the pretrained target areas or after the detection of the pretrained target areas. This also applies to the training process discussed above. The training process is also independent whether the region of interest or the target area is detected first.

The pretrained region of interest can be at least one part of at least one object or at least one object. The object can be a discrete object. A discrete object is an object with well-defined boundaries and spatial extension and thereby spatially invariant properties. Thus, the object can be anything that is visible and/or tangible and that can be touched like cars, chairs, etc. Additionally or alternatively the object can be such small that an image thereof can be acquired by the image acquisition device, in particular by a camera and/or mobile phone and/or tablet and/or a microscope, etc.

The pretrained target area can differ in an optical property from the region of interest. For example, the pretrained target area can have another color, brightness, etc. Additionally or alternatively, the pretrained target area can correspond to or is smaller than the region of interest. In other words, the pretrained target area can have a specific shape wherein the cross section of the shape can be smaller than the cross section of the region of interest. The pretrained target area can correspond to a defect in the region of interest, in particular the object. Additionally or alternatively, the pretrained target area can have an optical property, for example a color, that differs from an optical property of the pretrained region of interest.

The image mask can be configured such that it removes one or more pretrained target areas that are arranged outside of the pretrained region of interest. Additionally or alternatively, the image mask can be applied on the image data after the one or more trained target areas are detected. That means, the image is configured such that it does not remove the one or more pretrained target areas that are arranged in at least one region of interest. If the image data does not comprise a region of interest, the image mask removes all pretrained target areas. Masking of the image data is used to simplify and/or accelerate the processing of the pretrained target areas as all image regions that are not interesting and/or relevant are removed from the image data. Thus, image processing is faster after image masking as the image data to be processed is smaller than if the total image data has to be processed. The image mask can be applied on the complete image data and not only on a part of the image data.

The image mask creation process can occur as follows. The received image is represented by a matrix. Said matrix can comprise values for each pixel of the image. The image mask can also be represented by matrix. In a first step the values of the image mask can have the value 0. After the one or more region of interests are detected the values of the image mask can be modified in a second step. The modification of the pixel values of the image mask occurs such that by applying the image mask with the modified values on the received image the image regions that do not comprise the region of interest are removed. This can be achieved if the pixel value that corresponds to a non-interesting region of interest is 0. Alternatively, the pixel value can have a different value based on which it can be determined that said pixel does not belong to the region of interest.

The image mask that is represented by the matrix that is determined as discussed above is applied on a received image as follows. As mentioned above the received image can also be represented by a matrix. By applying the image mask on the received image the output is a matrix in which the values will be either the values of the received image or modified by the image mask. The value can be modified by the image mask so that it is 0, however, different values are also possible. In the end, the pixels that belong to the region of interest can be identified by their value after the image mask is applied on the image.

The one or more target areas arranged in the pretrained region of interest can be visualized. That means, the output of the method and/or the data processing device can be for e.g. visualized on a display. Additionally or alternatively the pretrained region of interest and/or the removed image region is not visualized.

According to an embodiment the neural network can be a convolutional neural network. The neural network can comprise at least two layers. In the case the neural network comprises only two layers, the neural network comprises an input layer and an output layer. The neural network can comprise more than two layers.

The neural network can be configured that it also creates the image mask and/or detects the one or more region of interest. In that case the neural network performs all tasks, i.e. detecting the pretrained target, creating the image mask and detecting the region of interest. The tasks can be performed parallel to each other or subsequent to each other. The output of the neural network is the detected pretrained target area, the image mask and the detected region of interest. In this case only one neural network is executed in the data processing device.

Alternatively, a further neural network can be executed in the data processing device. The further neural network can be configured such that it creates the image mask and/or detects the region of interest. The further neural network can output the created image mask and the detected region of interest. The neural network and the further neural network can be executed parallel to each other or subsequently to each other. The same image data is inputted to both the neural network and the further neural network.

The further neural network can be a convolutional neural network. The further neural network can comprise at least two layers. In the case the further neural network comprises only two layers, the further neural network comprises an input layer and an output layer. The further neural network can comprise more than two layers. In said embodiment, the neural network outputs the detected pretrained target area and the further neural network outputs the detected region of interest and the created image mask.

The one or more pretrained target area that is arranged in the at least one region of interest is determined by intersection of the detected one or more pretrained target areas and the detected one or more region of interests. The intersection process can be performed by the data processing device on the basis of the output of the neural network and/or the further neural network. Alternatively, it is possible that the intersection process is executed by the neural network. This is possible if only one neural network is provided.

The intersection process is performed on the detected two dimensional image and works as follows. The one or more detected target area can be assigned one or more polygons and the one or more detected region of interest can be assigned one or more other polygons. That means, a polygon is assigned to each target area and a further polygon is assigned to a region of interest. The polygon is configured such that it comprises the target area. Likewise, the other polygon is configured such that it comprises the region of interest. When a polygon of a target area and another polygon of region of interest have overlap or have a common surface the target area and the region of intersect with each other. In this case and dependent on the overlapping portion a part of the target area or the full target area is considered. When the polygon and the other polygon do not have any overlapping portions or do not have a common surface, then the target area and the region of interest do not intersect and thus the target area is not considered.

According to an embodiment the data processing device can be configured such that the region of interest is detected on the basis of a provisory region of interest. The provisory region of interest is detected by the neural network or the further neural network on the basis of the inputted image data. Said provisory region of interest often does not match with the region of interest shown in the image. Thus, the data processing device can determine whether in a predetermined region comprising at least a part of the rim of the provisory region of interest a rim of a region of interest shown in the image is arranged. The predetermined region can be a region with predefined number of pixels in height and width direction.

The data processing device can set the region of interest to be, in particular the rim of the, region of interest shown in the image if the provisory region of interest is displaced from the rim of the region of interest shown in the image in the predetermined region. If the predetermined region does not comprise a rim of the region of interest that is displaced from the provisory region of interest, the data processing device sets the provisory region of interest to be the region of interest. The aforementioned approach improves the detection of the region of interest. In particular, it is ensured that the detected region of interest, in particular object, corresponds to the region of interest, in particular object, shown in the image.

The data processing device can determine the number of detected pretrained target areas. Additionally, the data processing device can determine whether the number of pretrained target areas corresponds to a predetermined number of target areas. The number of pretrained target areas can be used for a quality control. The data processing device can determine a quality of the region of interest on the basis of the detected one or more pretrained target areas. For example, the data processing device can determine that the region of interest, in particular the object, has a bad quality when the number of detected pretrained target areas does not correspond to a predetermined number of target areas.

According to an embodiment a training process is performed. In the training process the neural network and/or the further neural network are trained for the operation phase. The training goal is that the neural network detects one or more target areas in the image data. If only one neural network is provided, the training goal is that the neural network in addition detects one or more regions of interests and creates the image mask. For the case that the further neural network is executed on the data processing device, the goal of the further neural network is that the further neural network detects the one or more regions of interest and creates the image mask.

A training process of the neural network can correspond to a training process of the further neural network. That means, both neural networks can be trained in the same way. That means, the same training images can be inputted to both neural networks. The neural network can be trained with unmasked or masked training images and/or the further neural network can be trained with unmasked or masked training images. With “unmasked images” it is meant that no mask is applied to the training images and the training images inputted to the neural network and/or the further neural network correspond to the original training images. Thus, in unmasked training images no objects are removed. The training images can show a plurality of objects that do not correspond to the region of interest.

The training images inputted to the neural network and/or the further neural network in the training phase can comprise context information. Training images with context information means that the training images comprise the target area and/or region of interest to be trained. In contrary to that training images with non-context-information means that the training images can or cannot comprise the target area and can comprise a plurality of different objects, i.e. non-interesting regions.

The training process for training the neural network and/or the further neural network can comprise two training phases. The training can be performed to train detecting the target area and/or the region of interest.

In the first training phase training images comprising non-context information are inputted to the neural network and/or the further neural network. The first training phase can be performed only once and can be considered as general training in which the neural network is trained with a plurality of different objects. In the first training phase, the neural network and/or further neural network are trained with labelled images. By “labeled” is meant that the image data contains information about the image height, image width and other image information, such as the color. In addition, the image signal contains information about what objects, e.g. screws, chairs, stairs, etc., are provided in the image signal. In this case, the training images inputted in the first training phase can comprise the target area and/or the region of interest. The designated or classified objects are at least partially enclosed by a bounding box, so that the neural network recognizes where the predetermined transport material is located in the image data. The bounding box can be a polygon.

In the first training process, the neural network to be trained is inputted a large number of images, in particular, e.g., millions of images, which, as explained previously, contain information about the object and the position of the object. As described above, the images can show a variety of different objects, whereby the target area and/or region of interest can be included in the images, but does not have to be included.

After the first training phase is finalized, the neural network and/or the further neural network is trained in a second training phase. In the second training phase training images that comprise the target area and/or region of interest can be inputted to the neural network or the further neural network. The second training phase is used to train the neural network and/or the further neural network to the application in which the neural networks shall be used. Usually, the neural networks are trained again if they shall be used in another application.

During training, the neural network and/or further neural network to be trained can be inputted training images that contain the target area and/or the region of interest and possibly other objects, and training images that contain no target are and/or no region of interest. However, it is advantageous if 20-100%, in particular 80-95%, preferably 90-95%, of the supplied training images show the target area and/or the region of interest. In the second training phase, the same training images can be supplied as in the first training phase. Alternatively, different training images can be supplied. At least one training image, in particular a plurality of training images, can be fed to the neural network and/or the further neural network in the second training phase. Thereby, a part of the training images may be labeled and another part of the training images may not be labeled. Alternatively, all images may be unlabeled. In this case, all training images containing a target area and/or a region of interest are labeled. Training images that do not contain a target area and/or a region of interest are not labeled.

According to another aspect a data processing device is provided. The data processing device comprising means for carrying out an inventive method. Additionally, an image acquisition device for acquiring images is provided. The image acquisition device can be at least one of the following a camera, a mobile phone, microscope and a tablet. The data processing device can be part of the image acquisition device. Alternatively, the data processing device can be electrically connected to the image acquisition device. The acquisition device can be configured to acquire visible light. “Visible light” means that the acquired light has a wavelength in the range of 380 to 750 nanometers.

According to a further aspect of the invention a computer program product is provided wherein the computer program product comprises instructions which, when the program is executed by the data processing device, in particular a computer, cause the data processing device, in particular the computer, to carry out the steps of the inventive method. Additionally, a computer-readable data carrier is provided wherein the computer-readable data carrier has stored thereon the computer program product. Also a data carrier signal is provided wherein the data carrier signal carries the computer program product.

The inventive method can be used in a conveyor system. In particular the method can be used for a quality determination of the objects, in particular goods, transported in the conveyor system. The objects, in particular goods, can correspond to the region of interest or form a part of the region of interest or a part of the objects, in particular goods, can be the region of interest.

In the figures, the subject matter of the invention is shown schematically, with identical or similarly acting elements being mostly provided with the same reference signs. Therein shows:

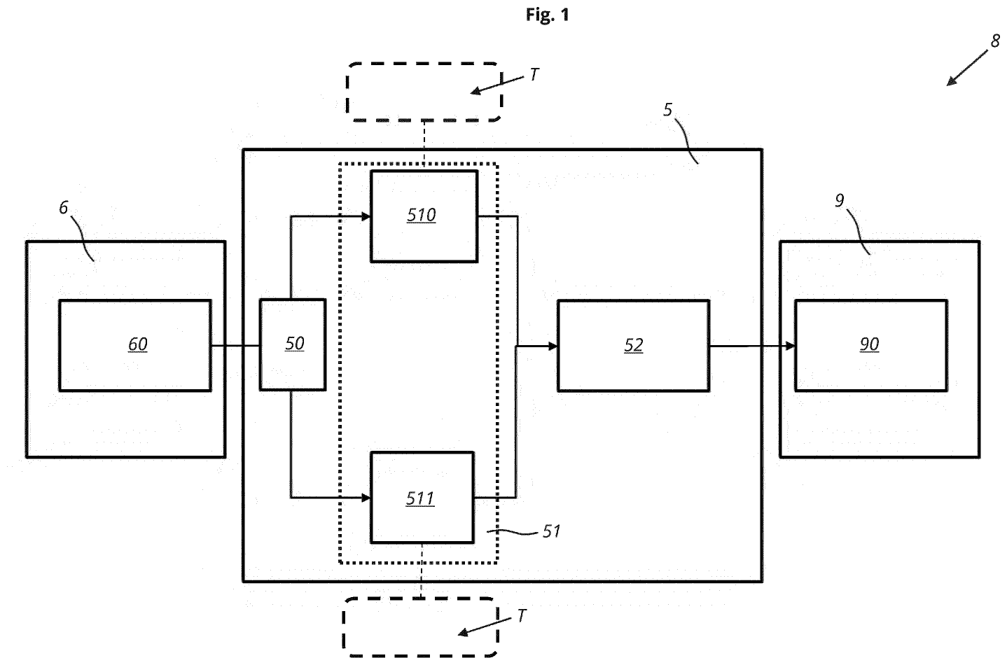

FIG. 1 a device with an image acquisition device and a data processing device executing an inventive method according to a first embodiment,

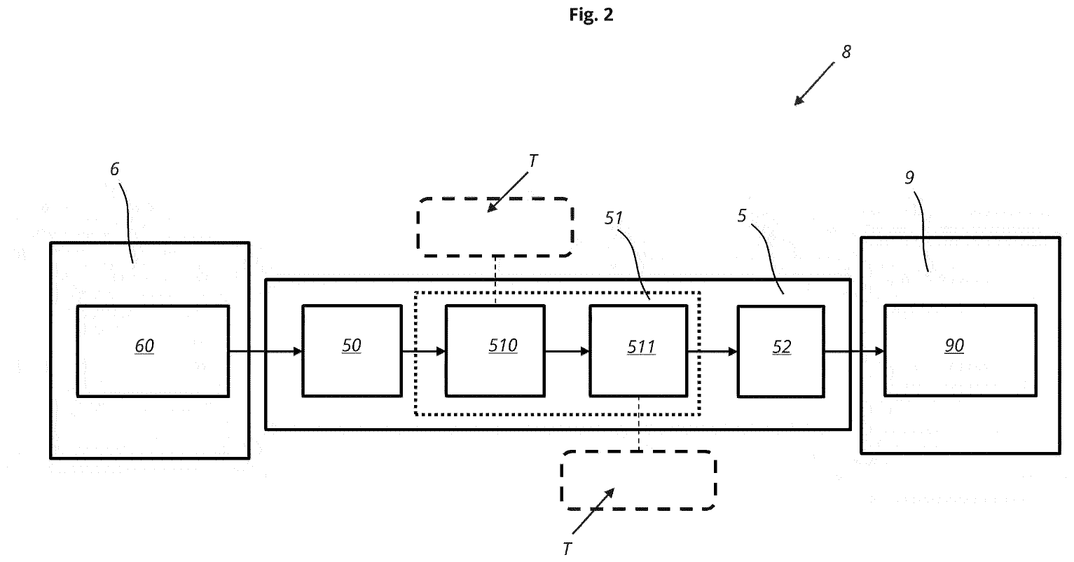

FIG. 2 a device with an image acquisition device and a data processing device executing an inventive method according to a second embodiment,

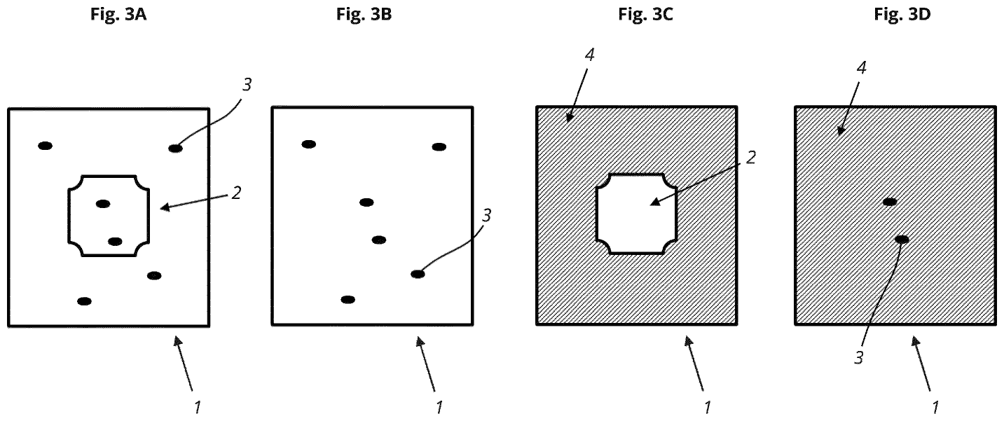

FIG. 3A-3B images showing the different processing steps of the inventive method,

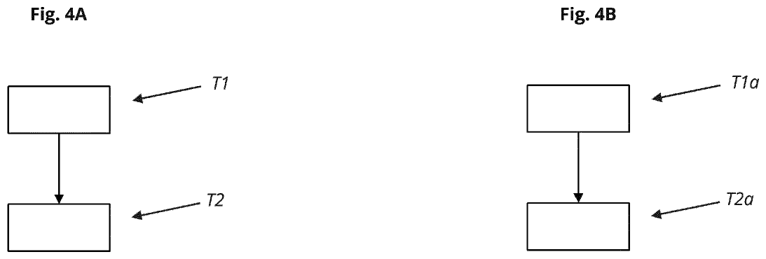

FIG. 4A shows a training phase for training the neural network to detect a target area

FIG. 4B shows a training phase for detecting a region of interest,

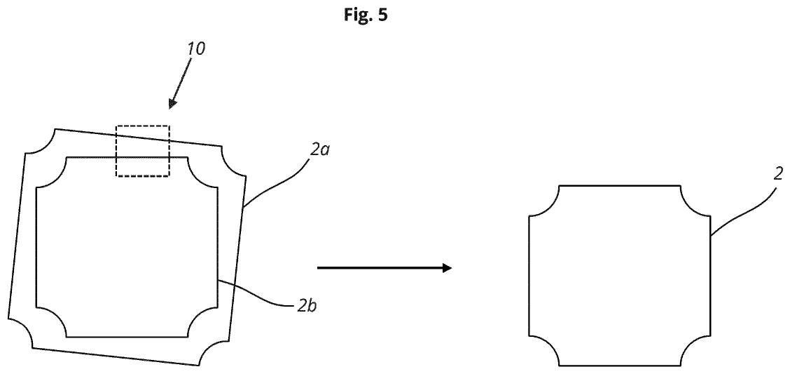

FIG. 5 a process for determining the region of interest,

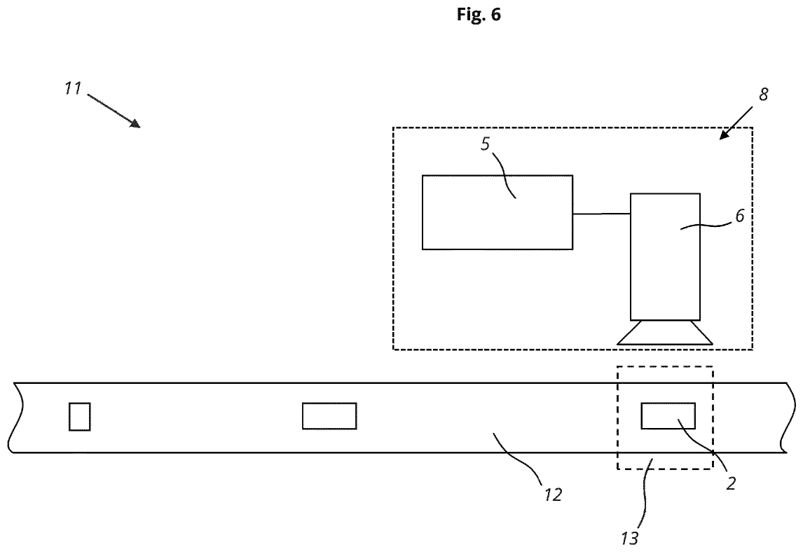

FIG. 6 a conveyor system comprising the device according to FIG. 1 or FIG. 2.

FIG. 1 shows a device 8 comprising an image acquisition device 6 and a data processing device 5, wherein the data processing device 5 is electronically connected to the image acquisition device 6 so that a data transfer between the two devices is possible. The image acquisition device 6 can comprise or be a camera. Alternatively, the image acquisition device 5 can be a camera or a mobile phone or a tablet or a microscope. The data processing device 5 can comprise at least one processor or be a processor. Alternatively, the data processing device 5 can be a computer.

The image is acquired by optical means, e.g. lens, of the image acquisition device 6. The acquired image data is outputted via an output section 60 of the image acquisition device 6. The output section 60 is connected to an input section 50 of the data processing device 5 so that a data exchange between the image acquisition device 6 and the data processing device 5 is possible.

The data processing unit 5 comprises a processing section 51. The processing section 51 comprises a first processing part 510 and a second processing part 511. The first processing part 510 comprises a neural network and the second processing part 511 comprises a further neural network. Both parts receive the image data received from the input section 50, Additionally, the data processing unit 5 comprises an intersection section 52. The intersection section 52 receives the output of the neural network and the further neural network. Additionally, the intersection section 52 functions as output of the data processing device 5 and is connected with a display input section 90 for data exchange between the data processing device 5 and the display 9 of the device 8.

In the following the method for processing the image acquired by the image acquisition device 6 is described.

In a first step an image 1 is acquired by the image acquisition device 6. Said image 1 is transmitted to the data processing device 5, in particular to the input section 50 of the data processing device 5. Said received image data is processed in the processing section 50. In particular, said image data is transmitted to the neural network of the first processing part 510 in second step. The transmitted image data is unmasked. The neural network detects one or more pretrained areas 3 in the second step. The output of the neural network is whether the image data comprises one or more pretrained target areas 3. In particular, the output of the neural network is the number and location of the one or more pretrained target areas 3 in the image 1. The output also includes the case in which the image data does not comprise a pretrained area 3. In said case the output of the neural network is that the image data does not comprise a pretrained area 3. The neural network is processed in a non-shown first processing section of the data processing device 5.

The neural network is pretrained to detect the one or more pretrained target areas 3. The training of the neural network is performed in a training process T that is explained in FIG. 4A more in detail. The neural network can be a convolutional neural network. Additionally or alternatively, the neural network can comprise at least two layers.

In a third step one or more region of interests 3 in the image 1 are detected in the processing section 51. The detection can be performed by the same neural network as discussed above in the second step S2.

Alternatively, the detection can be performed by a further neural network. Said case is shown in FIG. 1. Thereto, the image data received by the input section 50 is transmitted to the further neural network of the second processing part 511 in a third step. The transmitted image data can be unmasked. The further neural network detects whether the image data comprises one or more region of interests in the third step. Additionally, in the third step the further neural network creates an image mask wherein the image mask is dependent on the one or more region of interests 2. The image mask is created after the one or more region of interests 2 is detected. Further, in the third step, the image mask is applied on the image data. This results in that all image data is removed that does not comprise the one or more region of interests 2.

The output of the further neural network is whether the image data comprises one or more region of interests. In particular, the further neural network determines the number of region of interests and/or the location of the region of interest and the shape of the region of interest. With shape it is meant that the rim of the region of interest is determined. The image region 4 that does not comprise the one or more region of interests 2 is not outputted.

The further neural network is pretrained to detect the one or more region of interests 2. The training of the further neural network is performed in a training process T that is explained in FIG. 4B more in detail. The further neural network can be a convolutional neural network. Additionally or alternatively, the further neural network can comprise at least two layers.

The received image data is inputted to the neural network and the further neural network. The neural network and the further neural network can process the inputted image data parallel to each other.

In a fourth step the output of the output of the neural network and the output of the further neural network are intersected in the intersection section 52. This means, by intersecting the outputs of the two neural networks, the target areas 3 are detected that are arranged in a region of interest 2. The output of the fourth step is the information which target area 3 is arranged in a region of interest 2. Said output is transmitted to the display input section 90 and displayed in a fifth step.

It is possible to display the region of interest 2 with the one or more target areas 3 that is arranged in the region of interest 2. Alternatively, the region of interest 2 is not displayed so that only the one or more target areas 3 are displayed.

The aforementioned method steps are executed in the data processing unit 5 and specify the inventive computer-implemented method for processing the image 1.

FIG. 2 shows a device 8 with an image acquisition device 6 and a data processing unit 5 executing an inventive method according to a second embodiment. The second embodiment differs from the first embodiment shown in FIG. 1 in the processing order. In the second embodiment the image data received from the image acquisition device 6 is only inputted to the neural network of the first processing part 510 in the second step. The inputted image data is unmasked.

Afterwards, the output of the neural network is inputted to the further neural network of the second processing part 511 in the third step. The further neural network processes the output of the neural network. In particular, the further neural network processes the image data being part of the output of the neural network in a manner described in FIG. 1. Additionally, the further neural network does not process the target areas 3 detected by the neural network of the first processing part 510.

The data processing device 5 is configured to process the output of the further neural network in the fourth step. The output of the further processing device corresponds to the output of the neural network and the further neural network shown in FIG. 1. That means, the output of the further neural network shown in FIG. 2 is the information about the one or more target areas and the information about the one or more region of interest 2. Said information is processed in the fourth step such that an intersection process is performed in the intersection section 52. In the intersection process the one or more target areas 3 are identified that are arranged in a region of interest 2. The other method steps correspond to the method steps discussed in FIG. 1.

A further difference to the method discussed in FIG. 1 is that the data processing device 5 has to comprise the neural network and the further neural network to process the second and third step. In contrary to that and as mentioned above, in the embodiment shown in FIG. 1, the second and third step can be performed by the same neural network.

FIG. 3A-3D shows images 1 showing the different processing steps of the inventive method. FIG. 3A shows the image that is acquired by the image acquisition device 6. The image data of the acquired image 1 is transmitted to the data processing device 5. In both embodiments the image data is inputted to the neural network. The neural network of the processing section 51 detects the target areas 3 and does not determine the region of interest 2 as is shown in FIG. 3B. That means, the output of the neural network is the location and number of target areas 3. This information is processed in the fourth step by the data processing device 5. The image data that is inputted to the neural network is unmasked. That means, no image parts of the image acquired by the acquisition device 6 are removed and the inputted image data corresponds to the original image data as it is acquired by the image acquisition device 6.

FIG. 3C shows the output of the further neural network of the processing section 50. The image data of the image 1 shown in FIG. 3A is inputted to the further neural network. The further neural network creates an image mask that is dependent on the region of interest 2. Additionally, the further neural network applies the image mask on the inputted image data. Thus, the image region 4 that do not comprise a region of interest 2 are removed. Said image region 4 and the region of interest 2 are shown in FIG. 3C. Image data of the image shown in FIG. 3C are the output of the further neural network.

FIG. 3D show the outcome after the intersection process is performed by the data processing device 5. In the intersection process the image data of the image shown in FIG. 3B and the image data of the image shown in FIG. 3C are intersected. In particular, the target areas 3 are determined that are arranged in the region of interest 2. The other target areas 3 that are arranged outside of the region of interest 2 are removed. FIG. 3D shows the target areas that are detected by the neural network that are arranged in the region of interest 2 detected by the further neural network.

FIG. 4A shows a training process for training the neural network to detect a target area 3. The training process T comprises two training phases T1 and T2.

The first training phase T1 corresponds to a general training in which a plurality of training images are inputted to the neural network. The training images can comprise the target area 3 but do not have to. The training images, in particular all training images, inputted to the neural network in the first training phase T1 are labelled. Additionally, the training images show a plurality of different objects and/or an information about the location of the object. Thus, after the first training phase T1, the neural network knows to identify a plurality of different kind of objects. It is possible that the first training phase T1 is performed only once for training the neural network.

After the first training phase is finalized, the second training phase T2 is initiated. The second training phase T2 is used to train the neural network to the application in which the device 8 is to be used. Thus, the training images that are inputted to the neural network comprise the target area 3. Additionally, training images are inputted to the neural network that do not comprise the target area 3. In contrary to the first training phase at least some of the training images, or all training images are not labelled.

After the neural network performed the second training phase T2, it can recognize whether the inputted image data comprises one or more target areas 3.

FIG. 4B shows a training process for detecting a region of interest 2. Dependent on whether the data processing device 5 comprises only the neural network or the neural network and the further neural network, the training process is performed for the neural network or the further neural network. The statements below correspond to both cases, i.e. the training is the same independent on whether the further neural network is present or not.

The first training phase T1a corresponds to a general training in which a plurality of training images are inputted to the neural network or further neural network. The training images can comprise the region of interest 2 but do not have to. The training images, in particular all training images, inputted to the neural network in the first training phase T1a are labelled. Additionally, the training images show a plurality of different objects and/or an information about the location of the object. Thus, after the first training phase T1a, the neural network or further neural network knows to identify a plurality of different kind of objects. It is possible that the first training phase T1a is performed only once for training the neural network.

After the first training phase T1a is finalized, the second training phase T2a is initiated. The second training phase T2a is used to train the neural network to the application in which the device 8 is to be used. Thus, the training images that are inputted to the neural network or further neural network comprise the target area 3. Additionally, training images are inputted to the neural network or further neural network that do not comprise the target area 3. In contrary to the first training phase at least some of the training images, or all training images are not labelled.

After the neural network performed the second training phase T2a, it can recognize whether the inputted image data comprises one or more region of interest 2.

FIG. 5 shows a process for determining the region of interest 2. As is discussed above the neural network or the further neural network detect one or more region of interests 2. Thereto, an objection detection process is performed. FIG. 5 shows a preliminary region of interest 2a that is determined by the neural network or the further neural network. Additionally, FIG. 5 shows an original region of interest 2b as it appears in the image 1 acquired by the image acquisition device 6.

The data processing unit 5 examines in a predetermined region 10 whether a rim of the preliminary region of interest 2a is displaced from a rim of the origin region of interest 2b as is shown in image 1. If the rim of the preliminary region 2a is displaced, the data processing device 5 sets that the part of region of interest 2 corresponds to the rim part of the origin region of interest. This process is done along the circumference direction of the origin region of interest 2b. Thus, after the process the region of interest 2 to be used in the intersection process is determined. Said region of interest 2 is shown on the right side of FIG. 5 and is used in the intersection process discussed above.

FIG. 6 shows a conveyor system 11 comprising the device 8 according to FIG. 1 or FIG. 2. The conveyor system 11 comprises a conveyor belt 8 on which objects are transported. Said objects correspond to the region of interest 2 discussed above. The conveyor belt 12 is arranged such that it passes a monitoring area 13 of the image acquisition device 6. That means, all objects arranged on the conveyor belt 12 pass through said monitoring area 13. The object can correspond to the region of interest 2 or be a part of the region of interest 2.

The image acquisition device 6 acquires an image 1 of the monitoring area 13 including the object. Afterwards, the method discussed above is executed in the data processing device 5 to detect the one or more target area 3 in each region of interest 2.

### REFERENCE SIGNS

1 Image

2 Region of interest

2a Preliminary region of interest

2b Original region of interest

3 Target object

4 Region of no interest

5 Data processing unit

6 Image acquisition device

8 Device

9 Display

10 Predetermined region

11 Conveyor system

12 Conveyor belt

13 monitoring area

60 output section

50 input section

51 processing section

52 intersection section

510 first processing part

511 second processing part

90 display input section

T Training process

T1 First training phase

T2 Second training phase

1-26. (canceled)

27. A method for processing at least one image, the method comprising:
receiving of image data;
inputting the unmasked image data to an artificial neural network for detecting one or more pretrained target areas;
detecting one or more regions of interest in the image and creating an image mask that is dependent on the one or more regions of interest; and
applying the created image mask on the image data for removing an image region that does not comprise the one or more regions of interest; wherein
the one or more pretrained target areas that are detected are arranged in the one or more regions of interest.

28. The method according to claim 27, wherein the one or more regions of interest are detected before the image mask is applied on the received image data.

29. The method according to claim 27, wherein the one or more regions of interest is at least one part of at least one object or at least one object.

30. The method according to claim 27, wherein:
a. the pretrained target area differs in an optical property from the region of interest; and/or
b. the pretrained target area corresponds to or is smaller than the region of interest.

31. The method according to claim 27, wherein:
a. the image mask is configured so that it removes one or more pretrained target areas that are arranged outside of the region of interest; and/or
b. the created image mask is applied on the image data after the one or more pretrained target areas are detected.

32. The method according to claim 27, wherein:
a. the one or more target area arranged in the region of interest is visualized; and/or
b. the region of interest and/or the removed image region is not visualized.

33. The method according to claim 27, wherein:
a. the neural network is a convolutional neural network; and/or
b. the neural network comprises at least two layers.

34. The method according to claim 27, wherein the neural network creates the image mask and/or determines the region of interest.

35. The method according to claim 27, wherein a further neural network creates the image mask and/or determines the region of interest.

36. The method according to claim 35, wherein:
a. the further neural network is a convolutional neural network; and/or
b. the further neural network comprises at least two layers.

37. The method according to claim 27, wherein the one or more pretrained target areas that are arranged in the at least one region of interest are determined by intersection of the detected one or more pretrained target areas and the detected one or more regions of interest.

38. The method according to claim 37, wherein for determining the region of interest, a rim of a provisory region of interest is determined and it is determined whether in a predetermined region comprising at least a part of the rim of the provisory region of interest a rim of a region of interest shown in the image is arranged.

39. The method according to claim 38, wherein the region of interest is set to be the rim of the region of interest if the provisory region of interest is displaced from the rim of the region of interest in the predetermined region.

40. The method according to claim 27, wherein:
a. it is determined whether a number of pretrained target areas corresponds to a predetermined number of target areas; and/or
b. a quality of the region of interest is determined on the basis of the detected one or more pretrained target areas.

41. The method according to claim 35, wherein a training of the neural network corresponds to a training of the further neural network.

42. The method according to claim 27, wherein:
a. the neural network is trained with unmasked training images; and/or
b. the neural network is trained with training images, wherein the training images comprise context information.

43. The method according to claim 27, wherein training for the neural network comprises two training phases.

44. The method according to claim 43, wherein:
a. in a first training phase training images comprising non-context information are input to the neural network; and/or
b. in a second training phase training images that comprise the target area and/or the region of interest are input to the neural network.

45. A data processing device programmed to carry out the method according to claim 27.

46. A computer program product comprising instructions, which, when the program is executed by a data processing device cause the data processing device to carry out the method according to claim 27.
